(19) United States
(12) Patent Application Publication
(10) Pub. No.: US 2005/0037239 A1
(43) Pub. Date: Feb. 17, 2005

(54) Hard material layer

(76) Inventors: Bernd Karras, Deutschland (DE); Ursus Kruger, Deutschland (DE); Uwe Pyritz, Berlin (DE); Heike Schiewe, Berlin (DE)

Correspondence Address: YOUNG & THOMPSON, 745 SOUTH 23RD STREET, 2ND FLOOR, ARLINGTON, VA, 22202, US

(21) Appl. No.: 10/491,343

(22) PCT Filed: Oct. 1, 2002
(86) PCT No.: PCT/DE02/03743

(30) Foreign Application Priority Data
Oct. 1, 2001 (DE) 101493975

(51) Int. Cl. B32B 9/00

(52) U.S. Cl. 428/698

(57) ABSTRACT

A hard material layer having a relatively low frictional resistance, which can be produced by impregnating the layer with a lubricant. Zirconium oxynitride layer, which has zirconium-, nitrogen- and oxygen-containing phase, is used as a hard material layer. The presence of the phase in the zirconium oxynitride layer leads to a perceptible reduction of the layer frictional resistance, such that further processing steps can advantageously be saved on coating of substrates, such a impregnation. The coating (26) can, for example, be applied on a tool (27), which is appropriate for metal-cutting machining a work piece (28). With the low frictional resistance, a dry machining of the work piece (28) can be executed with the tool. Another application is the coating of highly stressed components of fuel injection valve.

The invention relates to a hard material layer with a relatively low frictional resistance.

Hard material layers of this type are disclosed by German Patent DE 44 18 517 C1. According to this document, it is possible for a wear-resistant layer consisting of hard materials to be applied to surfaces which are subjected to abrasive loads; on account of its hardness, this wear-resistant layer contributes to increasing the resistance to wear.

However, according to DE 44 18 517 C1, the wear-resistant layer has a relatively high frictional resistance. This can be reduced by impregnating the wear-resistant layer which is formed with suitable lubricants in a further process step carried out in vacuo under the application of pressure. In this step, by way of example inorganic lubricants which are able to withstand high temperatures and reduce the frictional resistance of the surface of the hard material layer are introduced into the latter.

The object of the invention is to provide a hard material layer with a relatively low frictional resistance which is relatively simple to produce.

According to the invention, the hard material layer is a zirconium oxynitride layer which includes a phase which contains zirconium, nitrogen and oxygen.

Although the dissertation “Röntgenstrukturuntersuchungen an Oxinitridschichten auf Chrom- und Zirkoniumbasis”, [X-ray structure analyses of oxynitride layers with a chromium and zirconium base] by Stéphane Collard, which was written at the Technical University of Chemnitz, Germany, has disclosed the production of oxynitride layers with a chromium and zirconium base with the aid of a reactive sputtering process, including a layer with a phase which contains zirconium, nitrogen and oxygen, this dissertation does not give any indication that a layer with a phase which contains zirconium, nitrogen and oxygen is distinguished not only by hardness but also by a low frictional resistance and therefore—unlike in the prior art dealt with in the introduction—can be produced in a single process step without any aftertreatment.

The invention is based on the discovery that the phase which contains zirconium, nitrogen and oxygen is primarily responsible for a surprisingly low frictional resistance of the zirconium oxynitride layer according to the invention compared to other hard material layers, in particular also other zirconium oxynitride layers which do not contain said phase. The zirconium oxynitride layer according to the invention does not have to be formed exclusively by this phase, but rather the layer composition may also contain phases of zirconium oxide or zirconium nitride.

The layers according to the invention, on account of their high hardness and their low frictional resistance, provide excellent wear protection to components which are subject to high loads. These layers can be produced by sputtering in a single process step, which means that they are very simple to produce. In particular, further treatment steps aimed at reducing the frictional resistance of the layer formed, for example impregnation with a lubricant, can be dispensed with. This results in a good cost-performance ratio when the zirconium oxynitride layer according to the invention is used in terms of the protection against wear which can be achieved and the production costs which are incurred.

According to one configuration of the invention, the phase which contains zirconium, nitrogen and oxygen has a defined crystal structure. The defined crystal structure of this phase makes an advantageous contribution to the abovementioned reduction in the frictional resistance of the hard material layer which includes this phase.

According to a further configuration of the invention, the phase of the zirconium oxynitride layer which contains zirconium, nitrogen and oxygen has a cubic crystal structure with a unit cell parameter a of between 0.511 nm and 0.532 nm. For this defined crystal structure, it has been found that the frictional resistance of the zirconium oxynitride layer which contains this phase is particularly low, so that this layer is particularly suitable for use for the coating of components which are subject to wear.

The zirconium oxynitride layer according to the invention can be produced, for example, by means of a reactive sputtering process. Production conditions which in this case lead, for example, to the formation of phases which contain zirconium, nitrogen and oxygen and have a defined crystal structure in a zirconium oxynitride layer are listed in the annex to the dissertation cited above. Accordingly, the reactive sputtering can be carried out using a zirconium target, with the distance between target and substrate to be coated being selected to be 6.5 cm. The production temperature is 400° C., with a discharge current of 1.5 A being maintained. Nitrogen and oxygen are supplied to the sputtering process, with the nitrogen flow rate being set at 2.8 sccm (standard cubic centimeters per minute), and it being possible for the oxygen flow rate to be varied between 0.25 and 2 sccm. Whereas at low and high oxygen flow rates only the formation of zirconium oxynitride layers with phases which contain zirconium and nitrogen and/or with phases which contain zirconium and oxygen is observed, the zirconium oxynitride layers according to the invention can be produced with a phase which contains zirconium, nitrogen and oxygen, and in particular has a defined crystal structure, at medium oxygen flow rates. By way of example, at oxygen flow rates of between 0.5 and 1 sccm, it is also possible for a phase of this type to be formed with a cubic structure and a unit cell parameter a of between 0.511 nm and 0.532 nm. The nitrogen content in the phase which contains zirconium, nitrogen and oxygen and has a defined structure may be between 30 and 44 atomic percent, and the oxygen content may be between 18 and 39 atomic percent.

Different applications result for the zirconium oxynitride layer according to the invention.

For example, according to German Patent Application DE 199 44 977 A1, to achieve a required service life it is proposed that coatings of chromium nitride or of carbon-containing tungsten carbide be applied to parts of fuel injection valves which can move relative to one another, so that the resistance to wear can be increased.

The object of the invention is to provide a fuel injection valve which has in relative terms an extended service life.

The object is achieved by a zirconium oxynitride layer with a phase which contains zirconium, nitrogen and oxygen and in particular has a defined structure being used as hard material layer for at least one of two valve parts, which are in contact with one another and can move relative to one another, in a fuel injection valve of an internal combustion engine. This defined structure may, for example, be a cubic structure with a unit cell parameter a of between 0.511 nm and 0.532 nm. This advantageously makes it possible to greatly reduce the wear on the coated component and also on the uncoated partner. A further improvement can be achieved if both components which move relative to one another are coated. The fuel which is delivered means that the lubrication state is less than optimum while the components are moving, since the fuel per se does not have optimum lubrication properties. However, it is not possible to add an additive in order to improve the lubrication properties, on account of the subsequent combustion in the internal combustion engine. Therefore, the layer structure according to the invention represents a solution for improving the wearing properties of the coated valve components. The reduction in the wear between the components which move relative to one another makes it possible to lengthen the surface life of the injection valve.

An advantageous embodiment of the invention is achieved if, with the first valve part being a valve seat having a valve needle and the second valve part having an injection opening which can be closed off by the valve needle, at least the valve needle is provided with the zirconium oxynitride layer according to the invention. The valve needle is the component which is subject to the highest loads in the injection valve and is therefore considered critical for the service life of the valve.

It is regarded as advantageous for the walls of the injection nozzle likewise to be coated. This makes it possible to further increase the expected service life of the fuel injection valve.

Furthermore, coated tools are known, for example from U.S. Pat. No. 6,284,356 B1. To extend the service life of the tool, the layers are applied to surfaces of the tool which are subject to high levels of load. They therefore serve as wear-resistant layers.

A further object of the invention is to provide a tool which by comparison has a longer service life.

This object is achieved by a zirconium oxynitride layer with a phase which contains zirconium, nitrogen and oxygen and in particular has a defined crystal structure being used as a surface layer on the tool. This advantageously allows wear to the tool to be reduced under frictional loading. This is achieved by virtue of the special properties of the phase which contains zirconium, oxygen and nitrogen and is present in the zirconium oxynitride layer, since this phase significantly reduces the frictional resistance of the layer compared to conventional tool coatings. A defined crystal structure may in particular be a cubic structure with a unit cell parameter a of between 0.511 nm and 0.532 nm. This opens up the possibility of tools which are provided with the zirconium oxynitride layer according to the invention being used for the dry machining of workpieces. Dry machining is to be understood as meaning machining of workpieces without the assistance of lubricants, in which case the dry lubrication properties of the layer according to the invention can be exploited. The elimination of coolants in, for example, material-removing machining of workpieces represents an enormous potential saving, since correspondingly designed machine tools make do without a lubricant circuit and the associated procurement and operating costs. At the same time, the environmental pollution caused by lubricants can be avoided, which not least is also of benefit to the economics of dry machining of workpieces, since the disposal of the lubricants incurs costs.

The layer according to the invention can advantageously be applied not only to tools for material-removing machining, but also to tools for chipless machining. Tools of the latter type are exposed to high frictional loads during the machining of the workpiece. The resultant wear can be beneficially reduced by the layers according to the invention. One example of a chipless machining process is fluting, which is used, for example, for thread forming.

The low frictional resistance of the zirconium oxynitride layer according to the invention opens up the possibility of using it as protection against wear for components which can be provided with little if any lubrication in use. In applications of this type, the absence or insufficient action of a lubricant can be compensated for by the expedient frictional properties of the layer.

This reduces the load not only on the coated component but also on a frictional partner which interacts with this component, irrespective of whether or not this frictional partner itself has any protection against wear.

Further details of the invention are to be found in the drawing, but these do not constitute any restriction to the claimed invention. In the drawing:

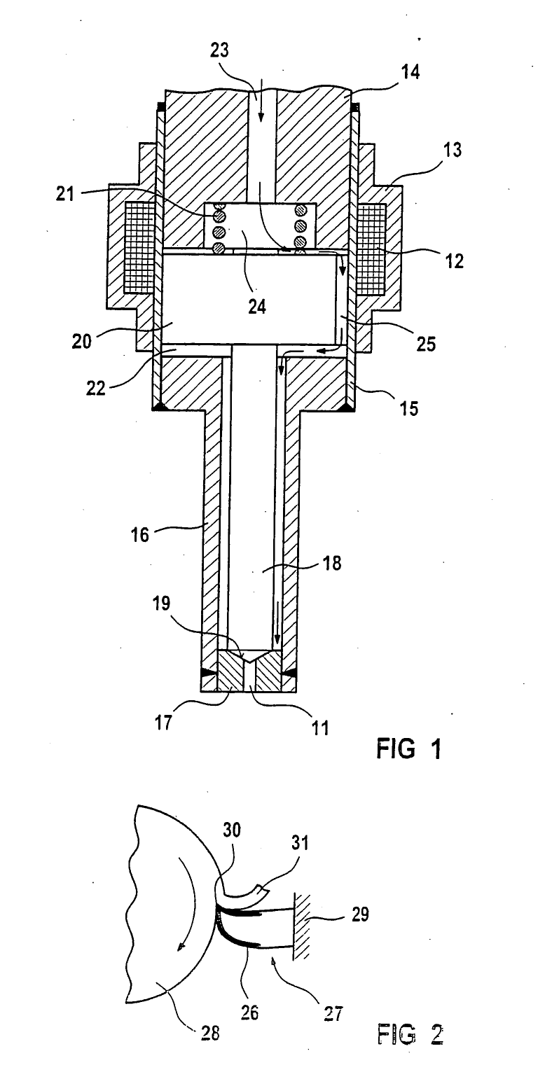

FIG. 1 diagrammatically depicts an exemplary embodiment of a fuel injection valve of an internal combustion engine, taken centrally in section, and

FIG. 2 diagrammatically depicts an exemplary embodiment of a tool in the form of a turning tool.

FIG. 1 illustrates a fuel injection valve which can be installed in a cylinder head (not shown), in such a manner that it has an injection opening 11 opening out into the combustion chamber (likewise not shown) of the cylinder. The fuel injection valve, also comprises, as actuator, a magnet coil 12 which is encapsulated in a coil housing 13, a tubular inner pole 14 and a sleeve-like outer pole 15, which opens out into a nozzle body 16.

A valve seat body 17 which forms the injection opening 11 is introduced into the nozzle body 16. The valve is closed off by means of a valve needle 18, which can open and close the injection opening 11 by means of a seat surface 19. For this propose, the valve needle is secured to an armature 20 which the magnet coil 12 can move, counter to a closure force exerted by a spring 21, away from the valve seat toward an open position (not shown). In the open position, the fuel can be guided through a passage system 22, in accordance with the arrows indicated, the fuel being supplied to the injection opening 11 through a feed bore 23, an installation space 24 for the spring 21, a groove 25 in the armature 20 and the nozzle body 2.

To improve the resistance to wear, the valve needle 18 and the valve seat body 17 are provided with a zirconium oxynitride layer which includes a phase which contains zirconium, nitrogen and oxygen and has a defined structure (not shown in more detail). These two parts may be coated as individual parts and then subsequently fitted to the associated components of the injection valve. The layer is of particular importance in the region of the highly loaded valve seat surface 19; in this area, particularly thick layers can be achieved by suitable positioning of the components in the sputtering diode. However, it is also possible for the adjoining areas, i.e. the injection opening 11 in the valve seat body 17 and the stem of the valve needle 18 to be coated.

A further example of an application for the use of a zirconium oxynitride layer 26 is illustrated in FIG. 2. This is a tool 27 for the material-removing machining of a workpiece 28. The tool 27 is secured in a chuck 29, while the workpiece 28 rotates in the direction indicated by the arrow. This is therefore a simplified representation of the machining of the workpiece 28 by turning. The tool 27 peels off a chip 31 along a cutting edge 30, this chip shearing over part of the surface of the tool 27. No lubricants are used, but rather the zirconium oxynitride layer 26 has a phase which contains zirconium, nitrogen and oxygen and has a defined structure, so that it presents only a low frictional resistance to the chip 31. This allows dry lubrication.

1-7 (cancelled)

8. A hard material layer with a relatively low frictional resistance, the hard material layer comprising a zirconium oxynitride layer which includes a phase which contains zirconium, nitrogen and oxygen and has a cubic structure with a unit cell parameter between 0.511 nm and 0.532 nm.

9. Method of increasing the service life of at least one of two valve parts, which are in contact with one another and can move relative to one another, in a fuel injection valve of an internal combustion engine, which comprises applying a hard material layer comprising a zirconium oxynitride layer with a phase which contains zirconium, nitrogen and oxygen and has a cubic structure with a unit cell parameter between 0.511 nm and 0.532 nm to said at least one of two valve parts.

10. The method as claimed in claim 9, wherein the first valve part is a valve seat with a valve needle, the second valve part has an injection opening which can be closed off by the valve needle, and the hard material layer is applied to the valve needle.

11. The method as claimed in claim 10, wherein the injection opening has walls, and the hard material layer is applied to said walls of the injection opening.

12. Method of extending the service life of a tool, which comprises applying a zirconium oxynitride layer having a phase which contains zirconium, nitrogen and oxygen and has a cubic structure with a unit cell parameter between 0.511 nm and 0.532 nm as a surface layer on said tool.
